(19) United States
(12) Patent Application Publication
(10) Pub. No.: US 2002/0071562 A1
(43) Pub. Date: Jun. 13, 2002

(54) Method and system for encrypting shared documents for transit and storage

(76) Inventor: Thomas J. Parenty, Oakland, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/735,876

(22) Filed: Dec. 13, 2000

(51) Int. Cl. H04L 9/00; H04L 9/08

(52) U.S. Cl. 380/278; 713/151; 713/152; 380/281

(57) ABSTRACT

A method and system is provided for encrypting documents for transit and storage where the interactive end user has no direct responsibility and takes no action for creating, protecting, using or deleting an encryption key. A clear text document located on a client system is encrypted, and the cipher text document is transmitted from the client system to the encryption server system. At the request of the client system, a cipher text document stored on the encryption server system is retrieved, transmitted from the encryption server system to the client system, and decrypted. At the request of the client system, a clear text document stored on the encryption server system is retrieved, encrypted, transmitted from the encryption server system to the client system, and decrypted.

### CROSS-REFERENCES TO RELATED APPLICATIONS

This application claims priority from provisional application U.S. ______ filed Nov. 24, 2000, entitled, METHOD AND SYSTEM FOR ENCRYPTING DOCUMENTS USING TRANSPARENT KEY MANAGEMENT the disclosure of which is incorporated by reference.

### STATEMENT REGARDING FEDERALLY SPONSORED RESEARCH OR DEVELOPMENT

Not applicable.

### TECHNICAL FIELD

The present invention relates to a method and system for encrypting shared documents for transit and storage.

### BACKGROUND OF THE INVENTION

One fundamental problem of encrypting shared documents is securely distributing the keys to encrypt them. In the past, a number of different approaches have been employed used to distribute keys, including manual distribution of keys, e.g., on Mylar™ tape, centralized key distribution centers, e.g., as found in Kerberos, and public key infrastructures (PKI). All of these approaches have disadvantages. The manual distribution of keys does not scale well, while centralized key distribution centers and PKI infrastructures are expensive to build and maintain.

The requirement for pre-installed client software is an additional disadvantage of the various methods and systems of encrypting shared documents known to those skilled in the art. The requirement for pre-installed client software, such as is found with Kerberos and PKI-based Lotus Notes®, results in only being able to access encryption capabilities using computers on which the client software was pre-installed. Relying on pre-installed client software limits both the mobility and flexibility in the use of encryption.

The requirement of key management responsibilities for interactive end users is another disadvantages of the various methods and systems of encrypting shared documents known to those skilled in the art. For example, in PKI-based encryption systems, the interactive end user has responsibility for the protection and, in some cases, the generation of private keys. Placing the responsibility for the protection, or generation, or both, of private keys on the interactive end user introduces opportunities for mistakes that could compromise the security of the private key and, consequently, the security of the system.

Thus, there is a need for a method and system of encrypting shared documents that use public key cryptography, but do not require the infrastructure characteristic of the manual distribution of keys, centralized key distribution centers, or PKI. There is also a need for a method and system of encrypting shared documents that impose no key management responsibilities on the interactive end users or clients.

The security of any encryption-based system depends upon the security of encryption keys. The security of these keys is dependent upon the protections offered by the operating systems that manage the environments in which the keys reside. Most client operating system environments, e.g., Windows 95™, Windows 98™, Windows ME™, and Palm OS™ do not provide adequate long term protection for these keys. Consequently, there is a need for a method and system for document encryption where long term protection of encryption keys on client systems is not required. More particularly, there is a need for a method and system for document encryption where encryption keys reside on the client system for a period no longer than required by the actual encryption or decryption operations.

### SUMMARY OF THE INVENTION

The present invention provides a method and system for encrypting documents for transit and storage where the interactive end user has no direct responsibility, and takes no action, for creating, protecting, using or deleting an encryption key.

The present invention provides for the encryption of a clear text document located on a client system and the transmittal of the cipher text version of the clear text document from the client system to the encryption server system. Under the control of the encryption server system, an ECC public/private key pair is generated for the encryption server system. Under the control of the client system, a Java® encryption applet and an encryption server system EEC public key are requested from the encryption server system. Under the control of the encryption server system, the Java® encryption applet and the encryption server system EEC public key are transmitted to the client system over a secure channel. Under the control of the client system, the Java® encryption applet is installed and run on the client system to generate a Triple DES symmetric key. Under the control of the client system, a clear text document is encrypted with the Triple DES symmetric key, thereby creating a cipher text document. Under the control of the client system, the Triple DES symmetric key is encrypted with the encryption server EEC public key, thereby creating an encrypted Triple DES symmetric key. Under the control of the client system, the encrypted Triple DES symmetric key and the cipher text document are transmitted from the client system to the encryption server system. Under the control of the encryption server system, the cipher text document and the encrypted Triple DES symmetric key are stored in a storage medium.

The present invention provides for the retrieval of a cipher text document stored on the encryption server system, the transmittal of the cipher text document from the encryption server system to the client system, and the decryption of the cipher text document under the control of the client system. Under the control of the client system, the cipher text document is requested from the encryption server system. Under the control of the encryption server system, the encrypted Triple DES symmetric key used to encrypt the cipher text document is retrieved and the encrypted Triple DES symmetric key is decrypted using the encryption server system EEC private key, thereby creating a decrypted Triple DES symmetric key. Under control of the encryption server system, the Triple DES symmetric key is inserted into a Java® decryption applet, and the Java® decryption applet is sent to the client system over a secure channel. Under the control of the encryption server system, the cipher text document is sent to the client system. Under the control of the client system, the Java® decryption applet is installed, and the cipher text document is decrypted using the Java® decryption applet, thereby creating a clear text document.

The present invention provides for the retrieval of a clear text document stored on the encryption server system, the transmittal of the cipher text version of the clear text document from the encryption server system to the client system, and the decryption of the cipher version of the clear text document under the control of the client system. Under the control of the client system, the clear text document is requested from the encryption server system. A Triple DES symmetric key is generated under the control of the encryption server system and the clear text document is encrypted with the Triple DES symmetric key, thereby creating a cipher text document. Under the control of the encryption server system, the Triple DES symmetric key is inserted into a Java® decryption applet, and the Java® decryption applet is transmitted to the client system over a secure channel. Under the control of the encryption server system, the cipher text document is sent to the client system. Under the control of the client system, the Java® decryption applet is installed on the client system and the cipher text document is decrypted using the Java® decryption applet, thereby creating a clear text document.

### BRIEF DESCRIPTION OF THE DRAWINGS

FIG. 1 illustrates the overall system for document encryption, transit, and storage.

FIG. 2 is a block diagram illustrating the transmittal of a cipher text document to the encryption server system.

FIG. 3 illustrates the overall system for the transmittal of a cipher text document stored in a storage medium to a client system.

FIG. 4 is a block diagram illustrating the transmittal of a cipher text document stored in a storage medium to a client system.

FIG. 5 illustrates the overall system for the transmittal of a clear text document stored in a storage medium to a client system.

FIG. 6 is a block diagram illustrating the transmittal of a clear text document stored in a storage medium to a client system.

FIG. 7 illustrates a correlation table in which an entry is made to support the retrieval of an encrypted Triple DES symmetric key, a cipher text document, a clear text document, or any combination of the foregoing.

FIG. 8 is a block diagram illustrating the use of a correlation table to support the future decryption of a cipher text document.

FIG. 9 is a block diagram illustrating the decryption of a cipher text document, initially stored in a storage medium as a cipher text document, and subsequently stored in a storage medium as both cipher text document and as a clear text document version of the cipher text document.

FIG. 10 is a block diagram illustrating the decryption of a cipher text document upon receipt by the encryption server system.

### DETAILED DESCRIPTION OF THE INVENTION

The present invention provides a method and system for encrypting documents wherein the interactive end user has no direct responsibility and takes no action for creating, protecting, using or deleting an encryption key. The encryption server system is responsible for all key management operations, including key creation, protection, distribution, and deletion. A client system may request to transmit a document from the client system to the encryption server system. A client system may request that the encryption server system transmit a document to the client system.

The practice of using encryption protocols to ensure the authenticity of senders as well as the integrity of messages is well known in the art and need not be described here in detail. For reference, one of ordinary skill in the art may refer to Bruce Schneier, Applied Cryptography, Protocols, Algorithms, and Source Code in C. (2d Ed. John Wiley & Sons, Inc., 1995).

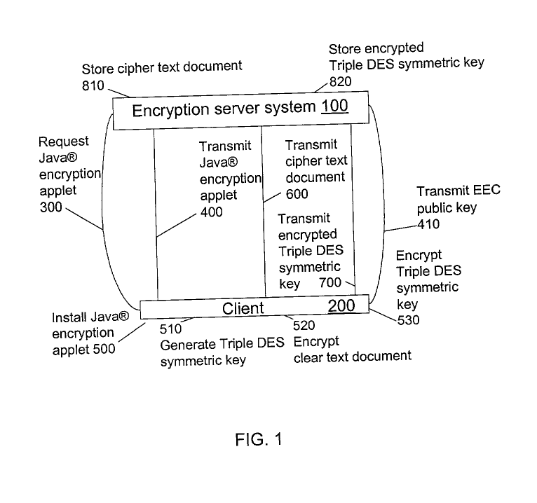

The method and system of the present invention will now be discussed with references to FIGS. 1-10. FIG. 1 illustrates the overall system for document encryption, transit, and storage. The system is comprised of an encryption server system 100 connected to at least one client system 200. Encryption server system 100 and at least one client system 200 may be connected via an Internet connection using a public switched phone network, e.g., those provided by a local or regional telephone company or by dedicated data lines. Connection may also be provided by cellular, Personal Communications Systems (PCS), microwave, satellite networks or other wireless networks. Connection may also be provided through the process of writing the communication to a medium, such as a floppy disk or write-able CD-ROM, and physically carrying it to the endpoint.

Encryption server system 100 is a computer. Client system 200 is a computer or any other device that can execute a computer program, including a personal digital assistant (PDA) or a cellular telephone. Encryption server system 100, or client system 200, or both encryption server system 100 and client system 200, act under the control of a human user, or on behalf of a human user, or under the control of a computer program.

For the purposes of the present invention, a document refers to electronic files that are shared in an office environment; more specifically, a document refers to electronic files in the following categories: word processing electronic files, e.g., Microsoft® Word electronic files; spread sheet electronic files, e.g., Microsoft® Excel electronic files; graphic presentation electronic files, e.g., Microsoft® PowerPoint electronic files; and, project planning electronic files. For the purposes of the present invention, a document does not refer to software programs or CAD/CAM electronic files.

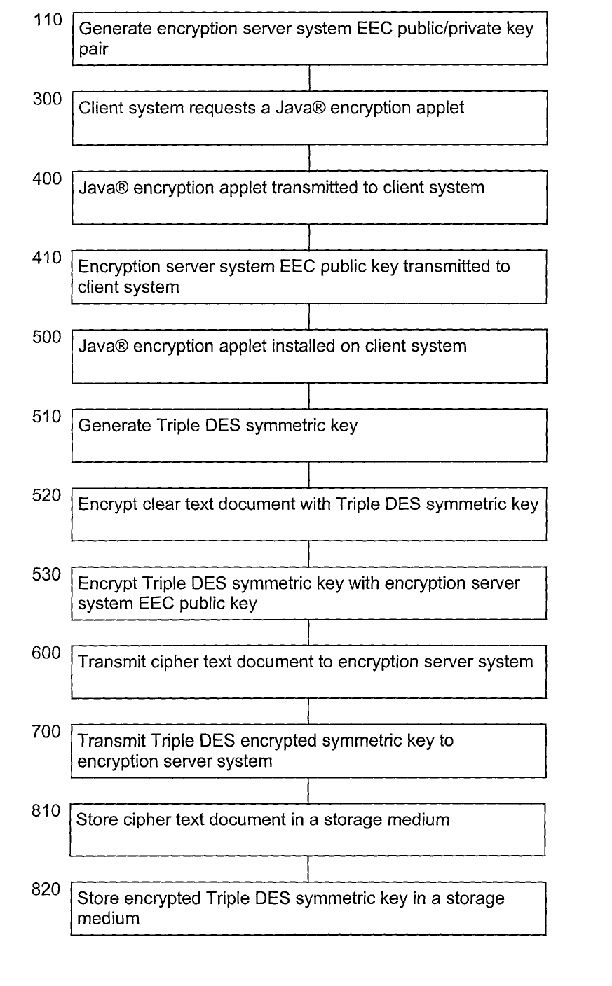

FIG. 2 is a block diagram illustrating the transmittal of a cipher text document to the encryption server system 100. An encryption server system EEC public/private key pair is generated, at step 110.

Referring to FIGS. 1 and 2, client system 200 issues a request to the encryption server system 100 for a Java® encryption applet, at step 300. Java® is a programming language developed by Sun Microsystems of Mountain View, Calif. Client system 200 accesses encryption server system 100 using HyperText Transfer Protocol (HTTP). The encryption server system 100 responds by transmitting a Java® encryption applet to client system 200 over a secure channel, at step 400. The encryption server system's EEC public key is transmitted to client system 200 over a secure channel, at step 410.

For the purposes of the present invention, cipher text refers to a document that has been encrypted, and clear text refers to a document that has not been encrypted or has been decrypted.

A secure channel means a communications channel having authenticated end points and provides that the content of the communications channel cannot be viewed or modified while being transmitted. The use of a secure channel, such as an encryption server system-authenticated Secure Sockets Layer (SSL) connection, ensures the confidentiality and integrity of a Java® encryption applet as it is being transmitted and provides client system 200 assurance that the Java® encryption applet did in fact come from encryption server system 100. Authentication is performed by the use of passwords or digital signatures. The choice of the authentication method used is based on a variety of factors, including, but not limited to, ease of use, sensitivity of the document, cost, and hardware support. It will be readily understood by one of skill in the art that authentication may be performed using other appropriate authentication methods.

Referring to FIGS. 1 and 2, client system 200 installs the Java® encryption applet, at step 500. For the purpose of this invention, installed refers to the actions that are necessary in order for a Java® encryption applet or a Java® decryption applet to execute. The execution of the Java® encryption applet by client system 200 is comprised of generating a Triple DES symmetric key, at step 510, encrypting the clear text document with the Triple DES symmetric key, at step 520, and encrypting the Triple DES symmetric key with the encryption server system's EEC public key, at step 530. The performance of steps 510, 520, and 530 creates a relationship between the encrypted Triple DES symmetric key and the cipher text document. The symmetric key generated at step 510 is a 168-bit Triple DES symmetric key (U.S. Government standard, specified in FIPS PUB 46-3).

Because the Triple DES symmetric key is generated on client system 200, at step 510, encrypts clear text document, at step 520, and is encrypted with the encryption server system's EEC public key, at step 530, the unencrypted Triple DES symmetric key resides on client system 200 for a period no longer than required by the actual encryption operations.

Once the Triple DES symmetric key has been encrypted, at step 530, the execution of the Java® encryption applet by the client may further include the step of deleting the encryption server system EEC public key from any storage medium under the control of client system 200. However, it will be understood by one of skill in the art that deleting the EEC public key from any storage medium under the control of client system 200 is not critical to security because possession of the encryption server system EEC public key alone cannot be used to decrypt the cipher text document.

As shown in FIGS. 1 and 2, client system 200 then transmits the cipher text document to encryption server system 100, at step 600. Client system 200 then transmits the encrypted Triple DES symmetric key to encryption server system 100, at step 700. The transmission of the cipher text document, at step 600, and the transmission of the encrypted Triple DES symmetric key, at step 700, may occur separately or together. The performance of steps 600 and 700 transmits the relationship created between the encrypted Triple DES symmetric key and the cipher text document to encryption server system 100.

The use of File Transport Protocol (FTP) is preferred for transmitting large cipher text documents because it is more efficient than sending the document over an SSL-encrypted HTTP link (HTTPS). The use of FTP with the Java® encryption applet has the additional benefit in that the cipher text document is still encrypted when it arrives at encryption server system 100. Use of an SSL link results in decryption of the cipher text document upon arrival at encryption server system 100 and storage of the clear text version of the cipher text document in a storage medium, at step 810.

As shown in FIGS. 1 and 2, the cipher text document is stored in a storage medium, at step 810. Referring to FIG. 2, the cipher text document may be stored, at step 810, in a storage medium as a cipher text document. Alternatively, at step 810, the cipher text document may be decrypted and stored in a storage medium as a clear text document. Alternatively, at step 810, the cipher text document may be stored in a storage medium as both a cipher text document and a clear text document. The encrypted Triple DES symmetric key is stored in a storage medium, at step 820.

For the purposes of the present invention, storage medium refers to both non-volatile, persistent storage, and primary memory. Examples of non-volatile, persistent storage include, but are not limited to, hard disk magnetic storage unit, optical storage unit, CD-ROM or flash memory. The storage medium is located on encryption server system 100.

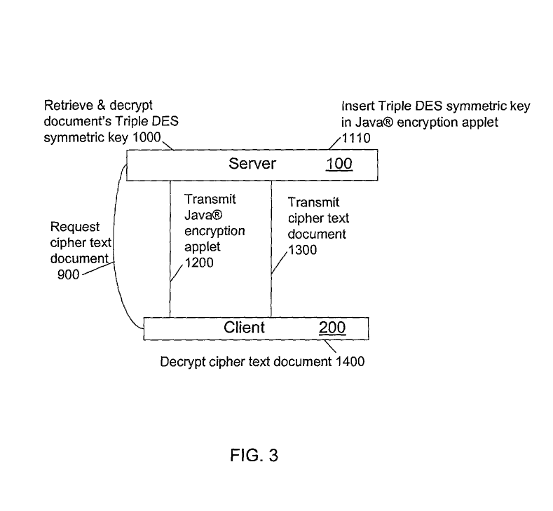

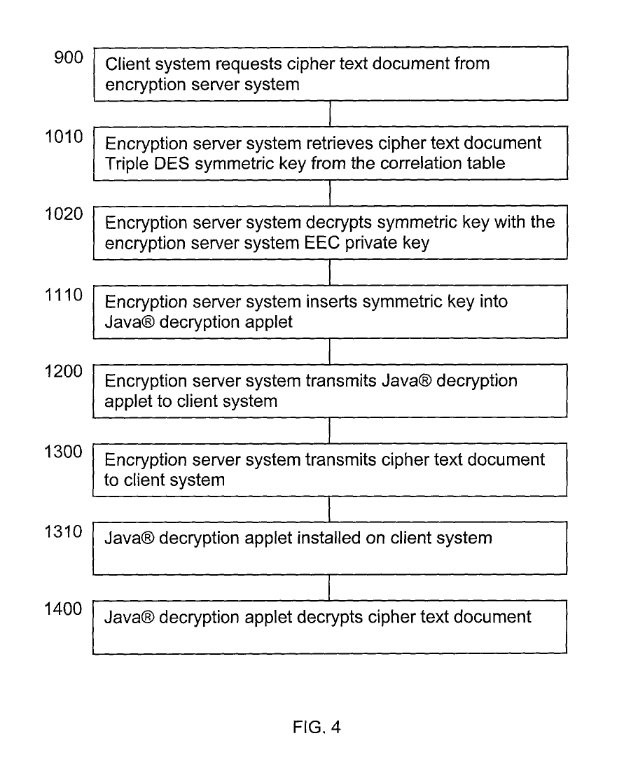

FIG. 3 illustrates the overall system for the transmittal of a cipher text document stored in a storage medium to client system 200. FIG. 4 is a block diagram illustrating the transmittal of a cipher text document stored in a storage medium to client system 200. Referring to FIGS. 3 and 4, at step 900, client system 200 requests a cipher text document from the encryption server system 100. Once client system 200 requests the cipher text document, at step 900, encryption server system 100 performs a series of actions. Referring to FIG. 3, at step 1000, and FIG. 4, at steps 1010 and 1020, encryption server system 100 retrieves and decrypts the Triple DES symmetric key used to encrypt the cipher text document. The encrypted Triple DES symmetric key is decrypted using the encryption server EEC private key. Referring to FIGS. 3 and 4, encryption server system 100 inserts the Triple DES symmetric key used to encrypt the clear text document into the Java® decryption applet at step 1110. Referring to FIG. 4, at step 1200, encryption server system 100 transmits the Java® decryption applet, having the inserted Triple DES symmetric key used to encrypt the clear text version of the cipher text document, to client system 200, using a secure channel. At step 1300, encryption server system 100 transmits the cipher text document to client system 200. Client system 200 installs the Java® decryption applet, at step 1310. At step 1400, the Java® decryption applet decrypts the cipher text document with the Triple DES symmetric key used to encrypt the clear text version of the cipher text document.

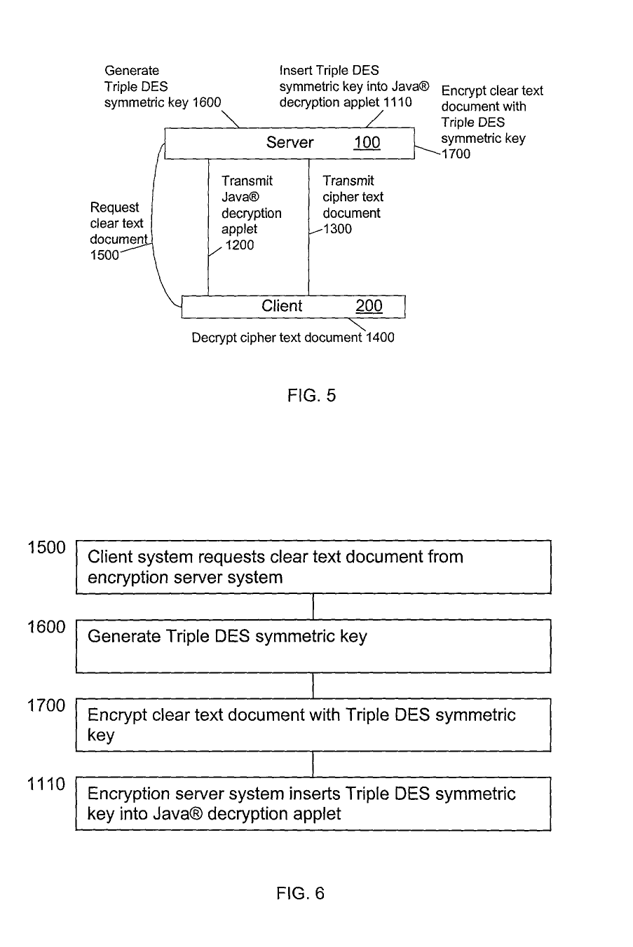

FIG. 5 illustrates the overall system for the transmittal of clear text document stored in a storage medium to client system 200. FIG. 6 is a block diagram illustrating the transmittal of clear text document stored in a storage medium to client system 200. Referring to FIGS. 5 and 6, at step 1500, client system 200 requests the clear text document from the encryption server system 100. Once client system 200 requests the clear text document, at step 1500, encryption server system 100 performs a series of actions. Referring to FIG. 5, encryption server system 100 generates a Triple DES symmetric key, at step 1600, and encrypts the clear text document with the Triple DES symmetric key, at step 1700. Encryption server system 100 inserts the Triple DES symmetric key used to encrypt the clear text document into the Java® decryption applet at step 1110. Referring to FIG. 4, at step 1200, the encryption server system 100 transmits the Java® decryption applet, having the inserted Triple DES symmetric key used to encrypt the clear text version of the cipher text, to client system 200, using a secure channel. At step 1300, encryption server system 100 transmits the cipher text document to client system 200. Client system 200 installs the Java® decryption applet, at step 1310. At step 1400, the Java® decryption applet decrypts the cipher text document with the Triple DES symmetric key used to encrypt the clear text version of the cipher text document.

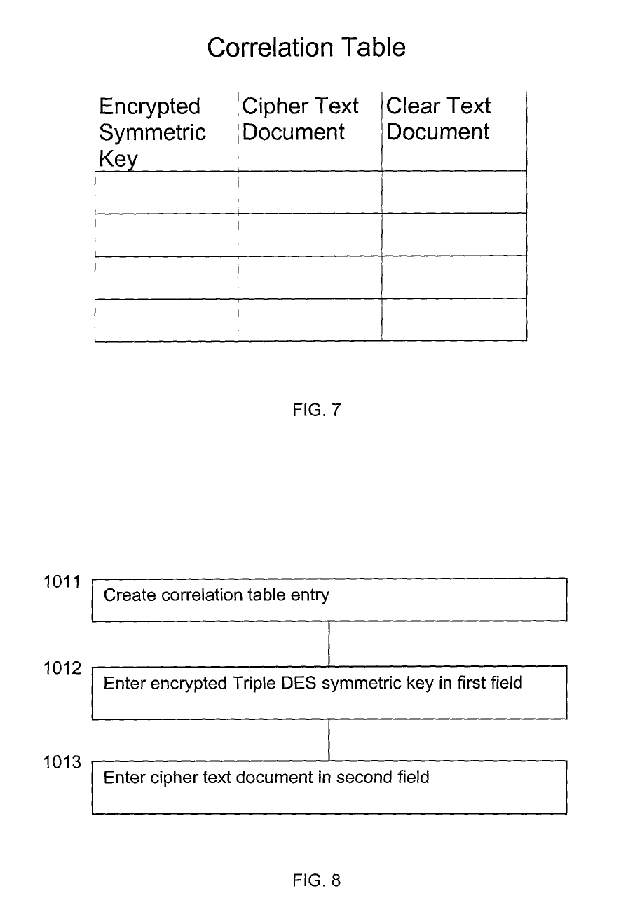

FIG. 7 illustrates a correlation table in which an entry is made to support the retrieval of an encrypted Triple DES symmetric key, a cipher text document, a clear text document, or any combination of the foregoing. For the purposes of the present invention, an entry is a tuple. Each entry or tuple in the correlation table corresponds to one document. The correlation table shown in FIG. 7 is comprised of at least one tuple having at least three fields. Any of the at least three fields may contain a null value. A first, second, and third field correspond to a first, second, and third item, respectively. Thus, the correlation table maintains a relationship between three fields each having a corresponding item. A first field corresponds to the encrypted Triple DES symmetric key used to encrypt the cipher text document. A second field corresponds to the cipher text document. A third field corresponds to the clear text version of the cipher text document. Making a first and second entry in the same tuple of the correlation table stores the relationship created between the encrypted Triple DES symmetric key and the cipher text document by the performance of steps 530, and 520.

The item entered in a field may be a pointer. A pointer is a location reference to another item. For example, the item entered in the first field may be a pointer referencing the location of an encrypted Triple DES symmetric key. It is advantageous to use a pointer when the item is larger than the pointer.

FIG. 8 is a block diagram illustrating the use of the correlation table to support the future retrieval of an item. Referring to FIG. 8, step 1011, encryption server system 100 creates a correlation table entry. At step 1012, encryption server system 100 enters the encrypted Triple DES symmetric key in the first field of the correlation table. At step 1013, encryption server system 100 enters the cipher text document in the second field of the correlation table.

The correlation table entry, at step 1011, may be made before any item is received by encryption server system 100; when at least one item is received by encryption server system 100; when at least one item is stored in a storage medium; or, when at least one item is received by encryption server system 100 and at least one item is stored in a storage medium.

Collapsing multiple operations into a single operation may optimize the use of the correlation table. Creating the correlation table entry, step 1011, storing the cipher text document in a storage medium, step 810, and entering the cipher text document in the second field of the correlation table, step 1013, may occur as one operation. Creating the correlation table entry, step 1011, storing the encrypted Triple DES symmetric key in a storage medium, step 820, and, entering the encrypted Triple DES symmetric key in the first field of the correlation table, step 1012 may occur as one operation.

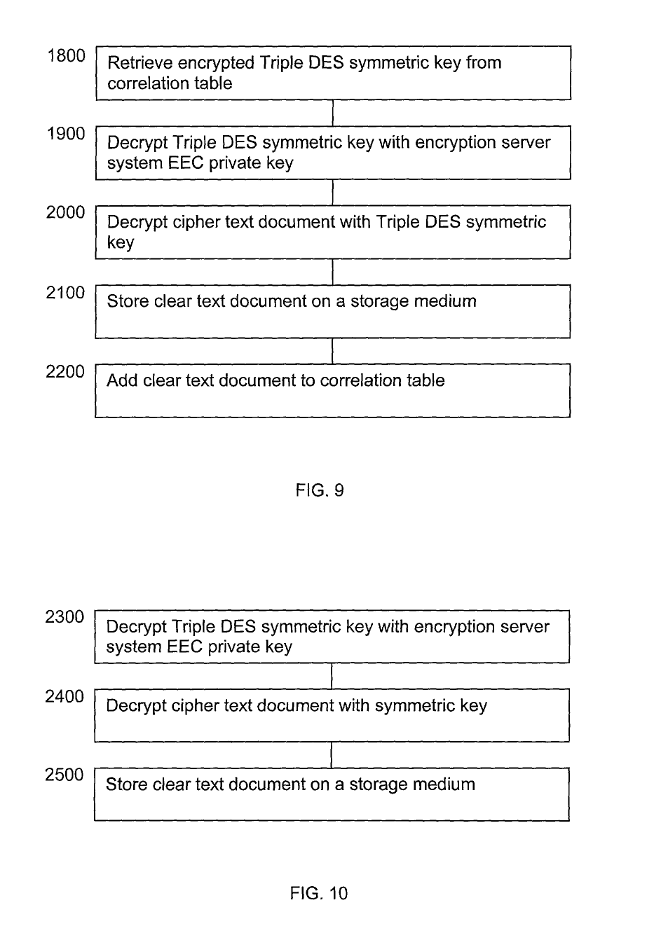

FIG. 9 is a block diagram illustrating the decryption of a cipher text document, initially stored in a storage medium, and subsequently stored in a storage medium as both cipher text document and a clear text document version of the cipher text document. Referring to FIG. 2, a document is initially stored in a storage medium as a cipher text document, at step 810. Referring to FIG. 9, encryption server system 100 retrieves the encrypted Triple DES symmetric key used to encrypt the cipher text document from a first field of the correlation table, at step 1800. Encryption server system 100 decrypts the encrypted Triple DES symmetric key with the encryption server system EEC private key, at step 1900. At step 2000, encryption server system 100 decrypts the cipher text document using the decrypted Triple DES symmetric key. The clear text version of the cipher text document is stored on a storage medium, at step 2100. At step 2200, encryption server system 100 enters the clear text document in the third field of the correlation table. Alternatively, at step 2200, encryption server system 100 enters a pointer to the clear text document in the third field of the correlation table. As an alternative to initially storing the clear text document, encryption server system 100 may perform another operation on the clear text document.

FIG. 10 is a block diagram illustrating the decryption of a cipher text document upon receipt by encryption server system 100. Referring to FIG. 2, at step 810, the cipher text document is stored in a storage medium, and, at step 820, the encrypted Triple DES symmetric key is stored in a storage medium. Referring again to FIG. 10 encryption server system 100 decrypts the encrypted Triple DES symmetric key with the encryption server system EEC private key, at step 2300. At step 2400, encryption server system 100 decrypts the cipher text document using the decrypted Triple DES symmetric key. The clear text version of the cipher text document is stored in a storage medium, at step 2500. The encryption server system 100 may enter the clear text document in the third field of the correlation table. Alternatively, encryption server system 100 may enter a pointer to the clear text document in the third field of the correlation table. Alternatively, the clear text document may not be initially stored, allowing encryption server system 100 to perform another operation on the clear text document.

The present invention may be deployed in an Application Service Provider (ASP) environment. Deploying the present invention in an ASP environment provides the advantage of having all or some of the operations of encryption server system 100 managed by a third party.

The Java® encryption applet and the Java® decryption applet may be installed on a browser, such as, Internet Explorer® or Netscape Navigator®.

The source code for the Java® encryption applet and the Java® decryption applet can be readily configured by one skilled in the art using well-known programming techniques and hardware components. Client system 200 functions may be accomplished by other means, including, but not limited to integrated circuits and programmable memory devices, e.g., EEPROM.

Those of skill in the art will recognize that the above described method and system of is merely illustrative of the principals of the present invention. Numerous modifications, variations, and adaptations thereof described will be readily apparent to those skilled in the art without departing from the spirit and scope of the present invention.

What is claimed is:

1. A method of encrypting a shared document, comprising:
under control of an encryption server system,
generating a ECC public/private key pair for the encryption server system;
under control of a client system,
requesting a Java® encryption applet from the encryption server system;
requesting an encryption server system EEC public key from the encryption server system;
under the control of the encryption server system,
transmitting the Java® encryption applet to the client system over a secure channel;
transmitting the encryption server system EEC public key to the client system over a secure channel;
under control of a client system,
receiving the Java® encryption applet from the encryption server system over a secure channel;
receiving the encryption server system EEC public key from the encryption server system over a secure channel;
installing the Java® encryption applet on the client system;
running the Java® encryption applet on the client system to generate a Triple DES symmetric key;
encrypting a clear text document with the Triple DES symmetric key, thereby creating a cipher text document;
creating a relationship between the cipher text document and the Triple DES symmetric key;
encrypting Triple DES symmetric key with the encryption server EEC public key, thereby creating an encrypted Triple DES symmetric key;
creating a relationship between the cipher text document and the encrypted Triple DES symmetric key;
transmitting the cipher text document to the encryption server system;
transmitting the encrypted Triple DES symmetric key to the encryption server system;
transmitting the relationship between the cipher text document and the encrypted Triple DES symmetric key to the encryption server system;
under the control of the encryption server system,
storing the cipher text document in a storage medium;
storing the encrypted Triple DES symmetric key in a storage medium; and
storing the relationship between the cipher text document and the encrypted Triple DES symmetric key in a storage medium.

2. The method of claim 1, wherein the secure channel is an SSL channel.

3. The method of claim 1, wherein the Java® encryption applet is installed on a browser.

4. The method of claim 3, wherein the browser is the Internet Explorer® or the Netscape Navigator®.

5. The method of claim 1, wherein the cipher text document is transmitted from the client system to the encryption server system using FTP, and the encrypted Triple DES symmetric key is transmitted to the encryption server system via HTTP.

6. The method of claim 1, wherein the cipher text document is transmitted from the client system to the encryption server system using FTP, and the document is decrypted upon arrival at the server.

7. The method of claim 1, further comprising the steps of:
under the control of the encryption server system,
storing the relationship between the cipher text document and the encrypted Triple DES symmetric key by making a first and a second entry in a correlation table, the first entry representing the encrypted Triple DES symmetric key, and the second entry representing the cipher text document.

8. The method of claim 7, wherein the first entry is the encrypted Triple DES symmetric key and the second entry is the cipher text document.

9. The method of claim 7, wherein the first entry is a pointer to the encrypted Triple DES symmetric key and the second entry is a pointer to the cipher text document.

10. The method of claim 1, further comprising the steps of:
under the control of the encryption server system,
decrypting the encrypted Triple DES symmetric key with the encryption server system EEC private key, thereby creating a decrypted Triple DES symmetric key;
decrypting the cipher text document with the decrypted Triple DES symmetric key, thereby creating a clear text document; and,
storing the clear text document on the encryption server system.

11. The method of claim 7, further comprising the steps of:
under the control of the encryption server system,
using the first entry in the correlation table to retrieve the encrypted Triple DES symmetric key;
decrypting the encrypted Triple DES symmetric key using the encryption server system EEC private key, thereby creating a decrypted Triple DES symmetric key;
decrypting the cipher text document with the decrypted Triple DES symmetric key, thereby creating a clear text document;
storing the clear text document on a storage medium; and
making a third entry in the correlation table, thereby creating a relationship between the cipher text document, the clear text document and the encrypted Triple DES symmetric key.

12. The method of claim 11, wherein the third entry is the clear text document.

13. The method of claim 11, wherein the third entry is a pointer to the clear text document.

14. The method of claim 7, further comprising the steps of:
under control of the client system,
requesting the cipher text document from the server;
under control of the encryption server system,
using the first entry in the correlation table to retrieve the encrypted Triple DES symmetric key;
decrypting the Triple DES symmetric key using the encryption server system EEC private key, thereby creating a decrypted Triple DES symmetric key;
inserting the Triple DES symmetric key into a Java® decryption applet;
sending the Java® decryption applet to the client system over a secure channel;
sending the cipher text document to the client system;
under control of the client system,
installing the Java® decryption applet on the client system; and,
decrypting the cipher text document using the Java® decryption applet, thereby creating a clear text document.

15. The method of claim 14, wherein the Java® decryption applet is installed on a browser.

16. The method of claim 15, wherein the browser is the Internet Explorer® or the Netscape Navigator®.

17. The method of claim 10, further comprising the steps of:
under control of the client system,
requesting the clear text document from the server;
under control of the encryption server system,
generating a Triple DES symmetric key;
encrypting the clear text document with the Triple DES symmetric key, thereby creating a cipher text document;
inserting the Triple DES symmetric key into a Java® decryption applet;
sending the Java® decryption applet to the client system over a secure channel;
sending the cipher text document to the client system;
under control of the client system,
installing the Java® decryption applet on the client system; and,
decrypting the cipher text document using the Java® decryption applet, thereby creating a clear text document.

18. The method of claim 17, wherein the Java® decryption applet is installed on a browser.

19. The method of claim 18, wherein the browser is the Internet Explorer® or the Netscape Navigator®.

20. The method of claim 11, further comprising the steps of:
under control of the client system,
requesting the clear text document from the server;
under control of the encryption server system,
generating a Triple DES symmetric key;
encrypting the clear text document with the Triple DES symmetric key, thereby creating a cipher text document;
inserting the Triple DES symmetric key into a Java® decryption applet;
sending the Java® decryption applet to the client system over a secure channel;
sending the cipher text document to the client system;
under control of the client system,
installing the Java® decryption applet on the client system; and,
decrypting the cipher text document using the Java® decryption applet, thereby creating a clear text document.

21. The method of claim 20, wherein the Java® decryption applet is installed on a browser.

22. The method of claim 21, wherein the browser is the Internet Explorer® or the Netscape Navigator®.

23. The method of claim 1, further comprising the steps of:
under the control of the encryption server system,
decrypting the encrypted Triple DES symmetric key with the encryption server system EEC private key, thereby creating a decrypted Triple DES symmetric key; and,
decrypting the cipher text document with the decrypted Triple DES symmetric key, thereby creating a clear text document.

24. A method of encrypting a shared document, comprising:
under control of a client system,
requesting a Java® encryption applet from the encryption server system;
requesting an encryption server system EEC public key from the encryption server system;
under the control of the encryption server system,
transmitting the Java® encryption applet to the client system over a secure channel;
transmitting the encryption server system EEC public key to the client system over a secure channel;
under control of a client system,
receiving the Java® encryption applet from the encryption server system over a secure channel;
receiving the encryption server system EEC public key from the encryption server system over a secure channel;
installing the Java® encryption applet on the client system;
running the Java® encryption applet on the client system to generate a Triple DES symmetric key;
encrypting a clear text document with the Triple DES symmetric key, thereby creating a cipher text document;
creating a relationship between the cipher text document and the Triple DES symmetric key;
encrypting Triple DES symmetric key with the encryption server EEC public key, thereby creating an encrypted Triple DES symmetric key;
creating a relationship between the cipher text document and the encrypted Triple DES symmetric key;
transmitting the cipher text document to the encryption server system;
transmitting the encrypted Triple DES symmetric key to the encryption server system;
transmitting the relationship between the cipher text document and the encrypted Triple DES symmetric key to the encryption server system;
under the control of the encryption server system,
storing the cipher text document in a storage medium;
storing the encrypted Triple DES symmetric key in a storage medium; and
storing the relationship between the document and the Triple DES symmetric key in a storage medium.

25. An encryption system for shared documents, comprising:
an encryption server system and a client system;
the encryption server system,
generating a ECC public/private key pair for the encryption server system;
transmitting the Java® encryption applet to the client system over a secure channel;
transmitting the encryption server system EEC public key to the client system over a secure channel;
storing the encrypted document in a storage medium;
storing the encrypted Triple DES symmetric key in a storage medium;
storing the relationship created between the document and the Triple DES symmetric key in a storage medium;
a client system,
requesting a Java® encryption applet from the encryption server system;
requesting an encryption server system EEC public key from the encryption server system;
receiving the Java® encryption applet from encryption server system over a secure channel;
receiving the encryption server system EEC public key from encryption server system over a secure channel;
installing the Java® encryption applet on the client system;
running the Java® encryption applet on the client system to generate a Triple DES symmetric key;
encrypting a clear text document with the Triple DES symmetric key, thereby creating a cipher text document;
creating a relationship between the cipher text document and the Triple DES symmetric key;
encrypting Triple DES symmetric key with the encryption server EEC public key, thereby creating an encrypted Triple DES symmetric key;
creating a relationship between the cipher text document and the encrypted Triple DES symmetric key;
transmitting the cipher text document to the encryption server system;
transmitting the encrypted Triple DES symmetric key to the encryption server system;
transmitting the relationship between the cipher text document and the encrypted Triple DES symmetric key to the encryption server system.

26. The encryption system of claim 25, wherein the encryption server system is further comprised of:
storing the relationship between the cipher text document and the encrypted Triple DES symmetric key by making a first and second entry in a correlation table, the first entry represents the encrypted Triple DES symmetric key, and the second entry represents the cipher text document.

27. The encryption system of claim 26, wherein the encryption server system is further comprised of:
making a third entry in the correlation table, wherein the third entry represents the clear text document;
creating a relationship between the cipher text document, the encrypted Triple DES symmetric key, and the clear text document; and,
storing the relationship between the cipher text document, the encrypted Triple DES symmetric key, and the cipher text document.

28. An encryption system for shared documents, comprising:
an encryption server system and a client system;
the encryption server system,
using the first entry in the correlation table to retrieve the encrypted Triple DES symmetric key;
decrypting the Triple DES symmetric key using the encryption server system EEC private key, thereby creating a decrypted Triple DES symmetric key;
inserting the Triple DES symmetric key into a Java® decryption applet;
sending the Java® decryption applet to the client system over a secure channel;
sending the cipher text document to the client system;
under control of the client system,
requesting the cipher text document from the server;
under control of the encryption server system,
installing the Java® decryption applet on the client system; and,
decrypting the cipher text document using the Java® decryption applet, thereby creating a clear text document.

29. An encryption system for shared documents, comprising:
an encryption server system and a client system;
under control of the encryption server system,
generating a Triple DES symmetric key;
encrypting the clear text document with the Triple DES symmetric key, thereby creating a cipher text document;
inserting the Triple DES symmetric key into a Java® decryption applet;
sending the Java® decryption applet to the client system over a secure channel;
sending the cipher text document to the client system;
under control of the client system,
requesting the clear text document from the server;
installing the Java® decryption applet on the client system; and,
decrypting the cipher text document using the Java® decryption applet, thereby creating a clear text document.

30. An encryption system for shared documents, comprising:
an encryption server system and a client system;
the encryption server system,
generating a ECC public/private key pair for the encryption server system;
transmitting the Java® encryption applet to the client system over a secure channel;
transmitting the encryption server system EEC public key to the client system over a secure channel;
storing the cipher text document in a storage medium;
storing the encrypted Triple DES symmetric key in a storage medium;
storing the relationship created between the cipher text document and the encrypted Triple DES symmetric key in a storage medium;
using the first entry in the correlation table to retrieve the encrypted Triple DES symmetric key;
decrypting the Triple DES symmetric key using the encryption server system EEC private key, thereby creating a decrypted Triple DES symmetric key;
inserting the encrypted Triple DES symmetric key into a Java® decryption applet;
sending the Java® decryption applet to the client system over a secure channel;
sending the cipher text document to the client system;
decrypting the encrypted Triple DES symmetric key using the encryption server system EEC private key, thereby creating a decrypted Triple DES symmetric key;
sending the cipher text document to the client system;
generating a Triple DES symmetric key;
encrypting the clear text document with the Triple DES symmetric key, thereby creating a cipher text document;
a client system,
requesting a Java® encryption applet from the encryption server system;
requesting an encryption server system EEC public key from the encryption server system;
receiving the Java® encryption applet from encryption server system over a secure connection;
receiving an encryption server system EEC public key from the encryption server system over a secure channel;
installing the Java® encryption applet on the client system;
running the Java® encryption applet on the client system to generate a Triple DES symmetric key;
encrypting a clear text document with the Triple DES symmetric key, thereby creating a cipher text document;
creating a relationship between the cipher text document and the Triple DES symmetric key;
encrypting Triple DES symmetric key with the encryption server EEC public key, thereby creating an encrypted Triple DES symmetric key;
creating a relationship between the cipher text document and the encrypted Triple DES symmetric key;
transmitting the document encrypted with the Triple DES symmetric key from the client system to the encryption server system;
transmitting the Triple DES symmetric key encrypted with the encryption server system EEC public key from the client system to the encryption server system;
transmitting the relationship between the cipher text document and the encrypted Triple DES symmetric key to the encryption server system;
requesting the cipher text document from the server;
installing the Java® decryption applet on the client system; and,
decrypting the cipher text document using the Java® decryption applet, thereby creating a clear text document; and,
requesting the clear text document from the server.
